(19) United States
(12) Patent Application Publication
(10) Pub. No.: US 2026/0219099 A1
(43) Pub. Date: Jul. 30, 2026

(54) WORKPIECE MASS ESTIMATION DEVICE

(71) Applicant: FANUC CORPORATION, Yamanashi (JP)

(72) Inventors: Yuuya KAWASE, Minamitsuru-gun, Yamanashi (JP); Yohei ARIMATSU, Minamitsuru-gun, Yamanashi (JP); Akira FUNAKOSHI, Minamitsuru-gun, Yamanashi (JP)

(73) Assignee: FANUC CORPORATION, Yamanashi (JP)

(21) Appl. No.: 19/147,297

(22) PCT Filed: Jan. 27, 2023
(86) PCT No.: PCT/JP2023/002683

§ 371 Date: Jul. 10, 2025

(51) Int. Cl. G01G 23/37; G01G 19/00

(52) U.S. Cl. CPC G01G 23/3721; G01G 19/00

(57) ABSTRACT

The purpose of the present invention is to facilitate confirmation of whether or not repeated computations have been processed normally. This workpiece mass estimation device is a device for a machine. The machine includes a motor that drives a workpiece loading unit and a sensor that detects the state of the motor. The workpiece mass estimation device is provided with an identification unit, a storage unit, an estimation unit, and a display. The identification unit: identifies the value of a physical parameter of a driven body driven by output of the motor on the basis of the state of the motor detected by the sensor; and continues to update the identified value through repeated computation. The storage unit saves the value of the physical parameter being updated. The estimation unit estimates the mass of a workpiece on the basis of the final value of the physical parameter being updated. The display displays a graph indicating the course of the values of the physical parameter on the basis of data saved in the storage unit and displays the mass estimated by the estimation unit.

### TECHNICAL FIELD

The present disclosure relates to a workpiece mass estimation device that estimates the mass of a workpiece loaded on various machines such as machine tools.

### BACKGROUND ART

Some machines such as machine tools each include a workpiece loading unit, a motor, a sensor, and a motor control unit. Workpieces are loaded on the workpiece loading unit. The motor drives the workpiece loading unit. The sensor detects the state of the motor. The state of the motor includes, for example, a current value and a rotational speed of the motor. The motor control unit performs feedback control of the motor based on the detected state of the motor.

### CITATION LIST

### Patent Document

Patent Document 1: Japanese Unexamined Patent Application, Publication No. 2015-55923

### DISCLOSURE OF THE INVENTION

### Problems to be Solved by the Invention

The total mass of the driven object driven by the motor varies depending on the mass of the workpiece loaded on the workpiece loading unit. Therefore, the inertia of the driven object also varies depending on the mass of the workpiece. The acceleration/deceleration of the driven object by the motor is changed by the change in the inertia. Excessive acceleration/deceleration imposes an excessive load, etc. on the machine, leading to machine failure, while insufficient acceleration/deceleration reduces the working efficiency of the machine. Therefore, it is necessary to adjust the acceleration/deceleration of the driven object by the motor to the optimal acceleration/deceleration. Therefore, some machines adjust the acceleration/deceleration of the driven object by the motor to the optimal acceleration/deceleration based on the mass of the workpiece input by the operator.

According to such a technique, although the acceleration/deceleration of the driven object can be adjusted, it is necessary for the operator to manually input the mass of the workpiece each time. Therefore, it has been proposed to automatically estimate the mass of the workpiece in the following manner. First, a predetermined operation command is sent to the motor control unit of the machine to cause the motor to drive the driven object. The inertia of the driven object at this time is identified based on a current feedback value, a rotational speed feedback value, detected by the sensor, etc. The inertia of the workpiece is calculated by subtracting the inertia caused by factors other than the workpiece from the identified inertia of the driven object, and the mass of the workpiece is estimated.

However, the present disclosers have focused on the fact that the following issue may occur in such a configuration.

In the process of estimating the mass of the workpiece, the values of the physical parameters may be sequentially updated by repetitive operations such as a steepest descent method. The physical parameters include the inertia of the driven object and parameters for calculating the inertia. The estimated mass of the workpiece is calculated based on the final values of the values of the physical parameters that have been updated. Therefore, the estimated mass of the workpiece depends on the final values.

When the repetitive operations are normally processed, there is no particular problem. However, if the repetitive operations are not processed normally, the values of the physical parameters will not converge within the time limit, and the final values will not be correct. As a result, a discrepancy occurs between the estimated mass of the workpiece and the actual mass of the workpiece.

The present disclosure has been made in view of the above circumstances, and an object of the present disclosure is to make it easy to check whether repetitive operations are being normally processed.

### Means for Solving the Problems

A workpiece mass estimation device of the present disclosure is a device for estimating a mass of a workpiece, for a machine including: a workpiece loading unit on which the workpiece is loaded; a motor for driving the workpiece loading unit; a sensor for detecting a state of the motor; and a motor control unit for controlling the motor based on the state of the motor detected. The workpiece mass estimation device includes:
an identification unit configured to identify a value of a physical parameter of a driven object driven by an output of the motor from the state of the motor detected and to update the identified value by repetitive operation;
a storage unit configured to store the value of the physical parameter as the value is updated;
an estimation unit configured to estimate the mass of the workpiece from a final value of the values of the physical parameter that have been updated; and
a display configured to display a graph indicating a transition of the value of the physical parameter based on data stored in the storage unit and to display the mass estimated by the estimation unit.

### BRIEF DESCRIPTION OF THE DRAWINGS

FIG. 1 is a schematic view showing a workpiece mass estimation device and a machine tool according to a first embodiment;

FIG. 2 is a flowchart showing a flow of mass estimation of a workpiece;

FIG. 3 shows a normal pattern displayed on a display;

FIG. 4 shows a first abnormal pattern displayed on the display;

FIG. 5 shows a second abnormal pattern displayed on the display;

FIG. 6 shows a third abnormal pattern displayed on the display; and

FIG. 7 shows a fourth abnormal pattern displayed on the display.

### PREFERRED MODE FOR CARRYING OUT THE INVENTION

### First Embodiment

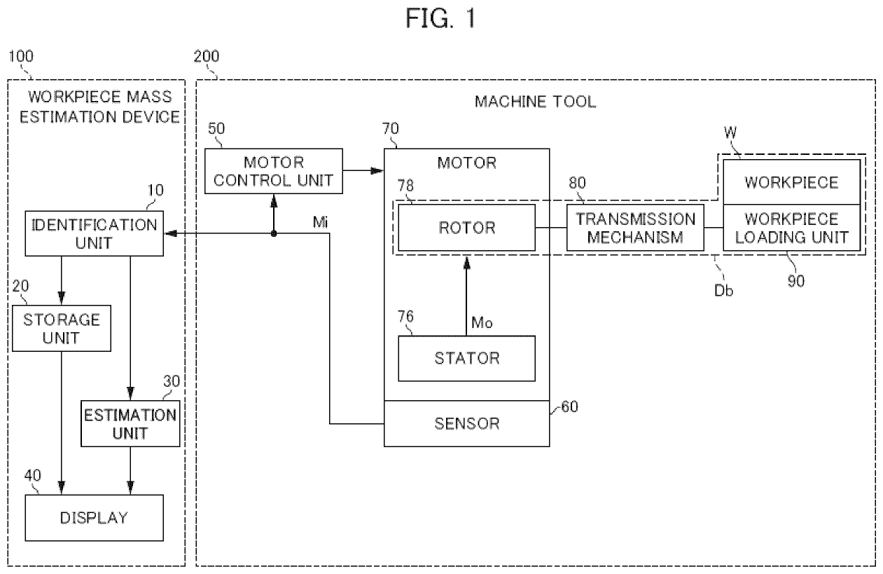

As shown in FIG. 1, a workpiece mass estimation device 100 of the present embodiment is installed for a machine tool 200. The machine tool 200 includes a motor control unit 50, a sensor 60, a motor 70, a transmission mechanism 80, and a workpiece loading unit 90.

The workpiece loading unit 90 is provided to be movable in a rotational direction or a linear direction. A workpiece W is loaded on the workpiece loading unit 90. The motor 70 includes a rotor 78 and a stator 76 that rotates the rotor 78. Hereinafter, the output from the stator 76 to the rotor 78 is referred to as “motor output Mo”. The transmission mechanism 80 transmits the motor output Mo from the rotor 78 to the workpiece loading unit 90. The transmission mechanism 80 may include a speed reducer such as a gear.

Hereinafter, the part of the machine tool 200 that transmits the motor output Mo to the workpiece loading unit 90 is referred to as a “transmission system”. The transmission system includes a transmission mechanism 80 and the periphery thereof. Hereinafter, the component group driven by the motor output Mo is referred to as a “driven object Dv”. The driven object Dv includes the rotor 78, the transmission mechanism 80, the workpiece loading unit 90, and the workpiece W. Hereinafter, the component group excluding the workpiece W from the driven object Dv is referred to as a “general driven object”.

The sensor 60 detects motor information Mi indicating the state of the motor 70. The motor information Mi includes a current value of the motor 70 and a rotational speed of the rotor 78. The motor control unit 50 performs feedback control of the motor 70 based on the motor information Mi detected by the sensor 60.

Next, the workpiece mass estimation device 100 will be described. The workpiece mass estimation device 100 is a device for estimating the mass of the workpiece W. Hereinafter, the estimation of the mass of the workpiece W is simply referred to as “mass estimation”, and the mass estimated by the mass estimation is simply referred to as “estimated mass”.

The workpiece mass estimation device 100 includes an identification unit 10, a storage unit 20, an estimation unit 30, and a display 40. The identification unit 10, the storage unit 20, and the estimation unit 30 are configured mainly by the same computer, for example. The display 40 mainly includes, for example, the above-described computer and a display. The computer includes, for example, a CPU, a ROM, a RAM, and a memory. In FIG. 1, the workpiece mass estimation device 100 and the machine tool 200 are shown separately from each other, but the workpiece mass estimation device 100 may be incorporated into the machine tool 200.

The identification unit 10 identifies the physical parameters of the driven object Dv from the motor information Mi detected by the sensor 60, and sequentially updates the identified values by repetitive operations such as a steepest descent method. The physical parameters include the inertia of the driven object Dv, a viscous friction coefficient in the transmission system, a Coulomb friction coefficient in the transmission system, and a spring constant in the transmission system. Hereinafter, the viscous friction coefficient in the transmission system is simply referred to as “viscous friction coefficient”, the Coulomb friction coefficient in the transmission system is simply referred to as “Coulomb friction”, and the spring constant in the transmission system is simply referred to as “spring constant”. The inertia of the driven object Dv is calculated in consideration of the viscous friction coefficient, the Coulomb friction coefficient, and the spring constant.

The storage unit 20 stores the values of the physical parameters as the values are updated by the identification unit 10.

When the final value of the values of the physical parameter that have been updated by the identification unit 10 is within a predetermined range, the estimation unit 30 performs mass estimation from the final value. Specifically, the estimation unit 30 calculates the inertia of the workpiece W by subtracting the inertia of the general driven object from the final value of the inertia of the driven object Dv identified by the identification unit 10. The inertia of the general driven object is calculated based on, for example, the mass of the general driven object input in advance. The estimation unit 30 performs mass estimation from the calculated inertia of the workpiece W. On the other hand, when the final value of the values of the physical parameter that have been updated by the identification unit 10 falls outside the predetermined range, the estimation unit 30 does not perform mass estimation.

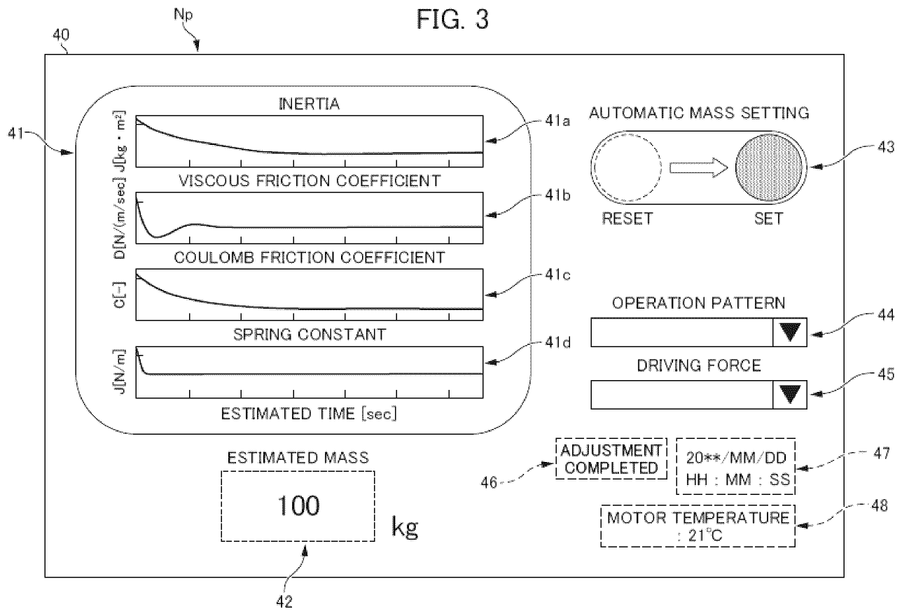

As shown in FIGS. 3 to 7, the display 40 displays a graph 41 showing the transition of the values of the physical parameters based on the data stored in the storage unit 20. The graph 41 includes an inertia graph 41a showing the transition of inertia, a viscous friction coefficient graph 41b showing the transition of viscous friction coefficient, a Coulomb friction coefficient graph 42c showing the transition of Coulomb friction coefficient, and a spring constant graph 42d showing the transition of spring constant.

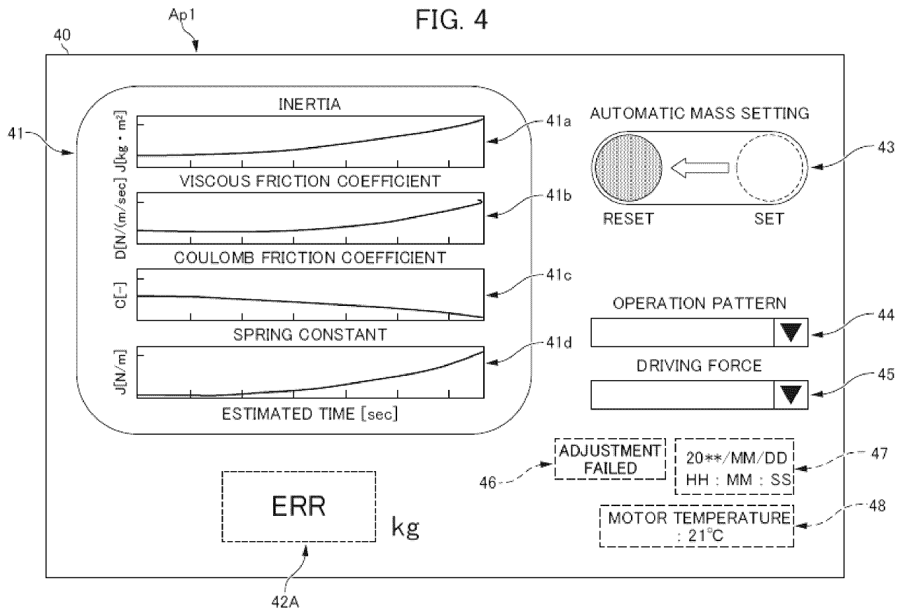

When the mass estimation is performed by the estimation unit 30, the display 40 displays mass information 42 indicating the estimated mass while displaying the graph 41 as shown in FIG. 3. On the other hand, when the mass estimation is not performed, that is, when the final value of the physical parameter falls outside the predetermined range, the display 40 displays an alarm 42A such as “ERR” instead of displaying the mass information 42, as shown in FIGS. 4 to 7. That is, the display 40 displays the alarm 42A while displaying the graph 41.

As shown in FIGS. 3 to 7, the display 40 displays a switching section 43, an operation pattern selection section 44, a driving amount selection section 45, status information 46, date and time information 47, and temperature information 48 while displaying the graph 41.

The switching section 43 is a part for performing an operation of switching between execution and suspension of mass estimation. The switching section 43 also serves as a reset section for initializing the estimated mass. The switching section 43 is configured to be selectable between “SET” and “RESET” by an operator. When “SET” is selected, execution of mass estimation is selected. On the other hand, when “RESET” is selected, the execution of mass estimation is suspended and the estimated mass is initialized. In the case where “SET” is selected, if an error such as the final value of the physical parameter falling outside the predetermined range occurs, the selection automatically returns to “RESET” as shown in FIGS. 4 to 7.

The operation pattern selection section 44 is a part for selecting an operation condition of the driven object Dv in mass estimation. The driving amount selection section 45 is a part for selecting the driving amount of the driven object Dv in mass estimation.

The status information 46 is information indicating whether the mass estimation is normally completed. That is, when the mass estimation is normally completed, as shown in FIG. 3, a message indicating that the mass estimation is completed is displayed as the status information 46, such as “adjustment completed”. On the other hand, when the mass estimation is not normally completed, as shown in FIGS. 4 to 7, a message indicating that the mass estimation is incomplete is displayed as the status information 46, such as “adjustment failed”.

The date and time information 47 is information indicating the date and time (year, month, day, time, etc.) when the mass estimation is completed. The temperature information 48 is information indicating the temperature of a predetermined part of the motor 70 in real time. The predetermined part is a part of the motor 70 in which the temperature affects the mass estimation.

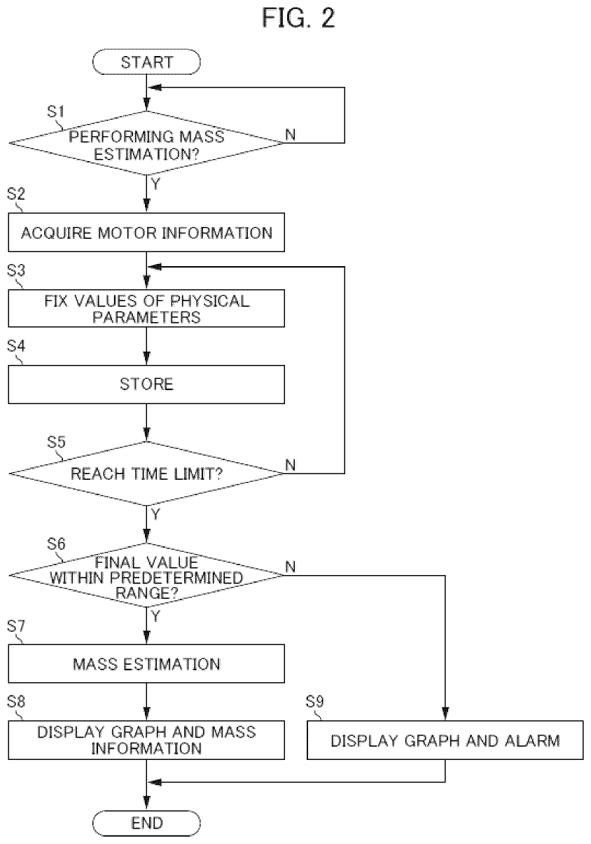

Next, with reference to FIG. 2, a flow of mass estimation by the workpiece mass estimation device 100 will be described. Note that “S” shown below is an abbreviation for “step”. First, in S1, it is determined whether mass estimation is being executed. When a negative determination N (No) is made, the determination of S1 is repeated. On the other hand, when an affirmative determination Y (Yes) is made in S1, the processing advances to S2.

In S2, the identification unit 10 acquires the motor information Mi from the motor control unit 50.

In S3, the identification unit 10 identifies the values of the physical parameters based on the motor information Mi. In S4, the storage unit 20 stores the identified parameter information. In S5, it is determined whether the duration of the estimation processing has reached a time limit. When a negative determination N is made, the processing returns to S3. As a result, the repetitive operations by the identification unit 10 are continued. On the other hand, when an affirmative determination Y is made in S5, the processing advances to S6.

In S6, it is determined whether the final value of the identified physical parameter is within a predetermined range set in advance. When an affirmative determination Y is made, the processing advances to S8. In S8, the estimation unit 30 estimates the mass of the workpiece W based on the final value of the identified physical parameter. In S9, the display 40 displays the estimated mass estimated by the estimation unit 30 as the mass information 42 while displaying the graph 41 based on the data stored in the storage unit 20.

On the other hand, when a negative determination N is made in S6, that is, when the identified final value of the physical parameter is not within the predetermined range set in advance, the processing advances to S9. In S9, the display 40 displays the alarm 42A while displaying the graph 41 based on the data stored in the storage unit 20.

Next, with reference to FIGS. 3 to 7, the display patterns displayed on the display 40 will be described.

The normal pattern Np shown in FIG. 3 indicates a case where the repetitive operations are normally processed. In the normal pattern Np, all the physical parameters converge. Therefore, in each of the inertia graph 41a, the viscous friction coefficient graph 41b, the Coulomb friction coefficient graph 41c, and the spring constant graph 41d, a behavior in which the value of the physical parameter converges appears.

In the first abnormal pattern Ap1 shown in FIG. 4, the repetitive operations are not normally processed for all the physical parameters. Therefore, in each of the inertia graph 411, the viscous friction coefficient graph 412, the Coulomb friction coefficient graph 413, and the spring constant graph 414, a behavior in which the value diverges appears.

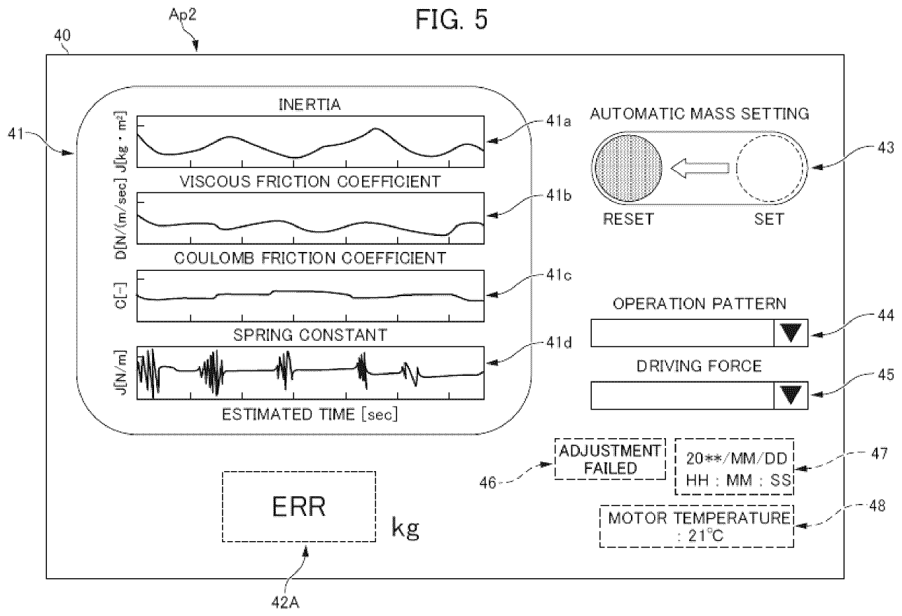

In the second abnormal pattern Ap2 shown in FIG. 5, a waved waveform appears in the inertia graph 411 due to unstable fixation of the workpiece W or an unsteady disturbance.

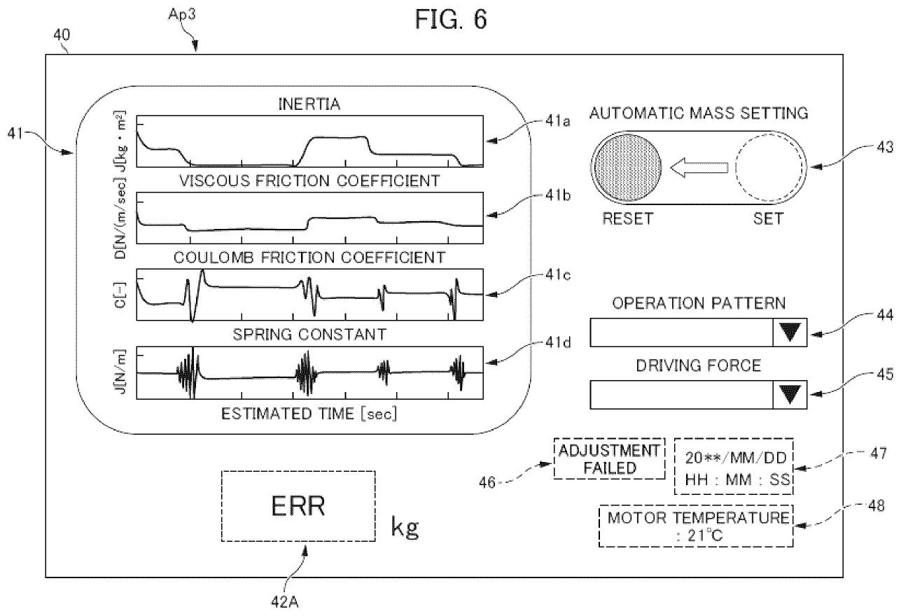

In the third abnormal pattern Ap3 shown in FIG. 6, a protrusion-like waveform appears in the Coulomb friction coefficient graph 41c due to wear deterioration of the sliding parts in the transmission system.

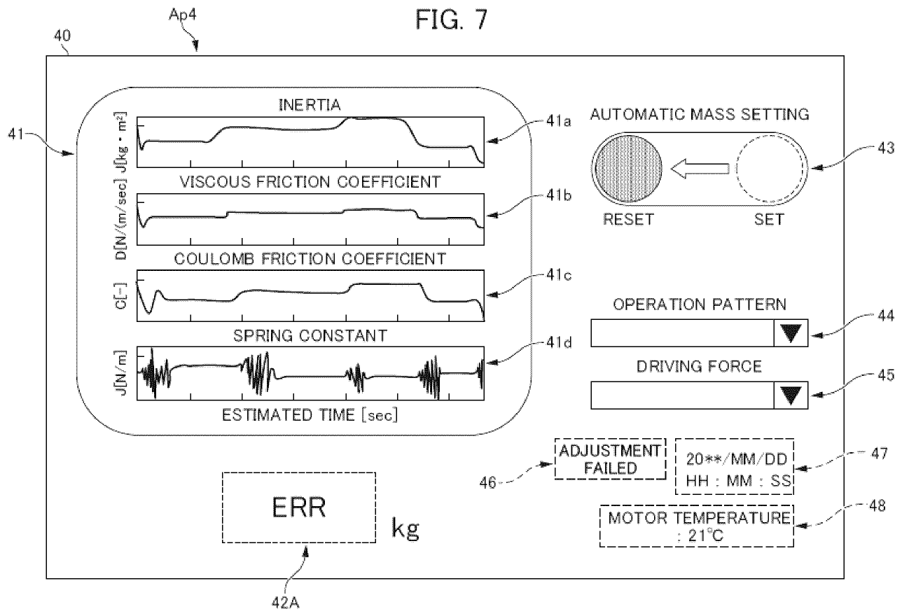

In the fourth abnormal pattern Ap4 shown in FIG. 7, the spring constant changes due to a change from elastic deformation to plastic deformation in parts of the transmission system. As a result, an irregularly divergent waveform appears in the spring constant graph 41d.

From the above, the operator can determine whether the repetitive operations have been normally processed based on the graph 41. Further, when the repetitive operations have not been normally processed, the cause can be determined based on the waveform appearing in the graph 41. That is, the operator can infer the cause of the failure of the mass estimation by determining which form of FIGS. 4 to 7 the behavior appearing in the graph 41 is similar to.

Hereinafter, the features and effects of the present embodiment will be summarized.

The display 40 displays the graph 41 and the mass information 42. Therefore, the operator can check whether the repetitive operations are being normally processed based on the graph 41 and can check the estimated mass based on the mass information 42. Further, when the repetitive operations have not been normally processed, the cause can be determined based on the waveform appearing in the graph 41. This facilitates the operator to perform the next appropriate process.

Specifically, the graph 41 includes the inertia graph 41a, the viscous friction coefficient graph 41b, the Coulomb friction coefficient graph 41c, and the spring constant graph 41d. When the repetitive operations are not normally processed, the behaviors shown in FIGS. 4 to 7 appear in the graphs 41a to 41d. Therefore, the operator can infer the cause of the failure of the mass estimation by determining which forms these behaviors resemble.

The display 40 displays the switching section 43 while displaying the graph 41. Therefore, the operator can switch between the execution and the suspension of the mass estimation by means of the switching section 43 while checking the trend of the repetitive operations, etc., based on the graph 41.

The display 40 displays the date and time information 47 while displaying the graph 41. Therefore, the operator can check the cause of the failure of the mass estimation based on the graph 41 while checking the date and time when the mass estimation is completed based on the date and time information 47 when the repetitive operations are not normally processed.

The display 40 displays the temperature information 48 in real time while displaying the graph 41. Therefore, the operator can check the cause of the failure of the mass estimation based on the graph 41 while checking the temperature of the motor 70 based on the temperature information 48 when the repetitive operations are not normally processed.

The display 40 displays the operation pattern selection section 44 while displaying the graph 41. Therefore, the operator can change the operation condition of the driven object Dv by means of the operation pattern selection section 44 while checking the cause of the failure of the mass estimation based on the graph 41, when the repetitive operations are not normally processed, for example.

The display 40 displays the drive amount selection section 45 while displaying the graph 41. Therefore, the operator can change the driving amount of the driven object Dv by means of the driving amount selection section 45 while checking the cause of the failure of the mass estimation based on the graph 41, when the repetitive operation is not normally processed, for example.

When the mass estimation is not normally completed, the display 40 displays a message indicating that the mass estimation is incomplete as the status information 46 while displaying the graph 41. Therefore, the operator can quickly recognize that the mass estimation is incomplete based on the status information 46, and can check the cause of the failure of the mass estimation based on the graph 41.

The switching section 43 also serves as a reset section for initializing the estimated mass. That is, the display displays the reset section while displaying the graph 41. Therefore, the operator can reset the estimated mass by means of the reset section as necessary while checking the trend of the repetitive operations, etc., based on the graph 41.

When the identified physical parameter falls outside the predetermined range, the display 40 displays the alarm 42A while displaying the graph 41. Therefore, the operator can quickly recognize the failure of the mass estimation based on the alarm 42A, and can check the cause of the failure based on the graph 41.

### Other Embodiments

The embodiment described above can be modified as follows, for example. The workpiece mass estimation device 100 may be installed for a machine other than the machine tool 200. Regarding the graph 41, some of the four graphs 41a to 41d described above may be omitted, or an additional graph may be added. The inertia graph 41a may indicate the transition of the inertia of the workpiece W instead of the transition of the inertia of the driven object Db. Some of the pieces of information 42A and 43 to 48 displayed together with the graph 41 other than the mass information 42 may be omitted, or additional information may be added. The switching section 43, the operation pattern selection section 44, the driving amount selection section 45, etc. may be displayed in a manner other than those shown in FIGS. 3 to 7.

According to the above embodiments, the workpiece mass estimation devices (100) of additional remarks 1 to 9 described below can be realized.

### ADDITIONAL REMARK 1

A workpiece mass estimation device (100) for estimating a mass of a workpiece (W), for a machine (200) including: a workpiece loading unit (90) on which the workpiece (W) is loaded; a motor (70) for driving the workpiece loading unit (90); a sensor (60) for detecting a state of the motor (70); and a motor (70) control unit for controlling the motor (70) based on the state of the motor (70) detected,
the workpiece mass estimation device (100) including:
an identification unit (10) configured to identify a value of a physical parameter of a driven object (Dv) driven by an output of the motor (70) from the state of the motor (70) detected and to update the identified value by repetitive operation;
a storage unit (20) configured to store the value of the physical parameter as the value is updated;
an estimation unit (30) configured to estimate the mass of the workpiece (W) from a final value of the values of the physical parameter that have been updated; and
a display (40) configured to display a graph (41) indicating a transition of the value of the physical parameter based on data stored in the storage unit (20) and to display the mass (42) estimated by the estimation unit (30).

### ADDITIONAL REMARK 2

The workpiece mass estimation device (100) according to additional remark 1, in which the display (40) displays a switching section (43) for performing an operation of switching between execution and suspension of estimation of the mass while displaying the graph (41).

### ADDITIONAL REMARK 3

The workpiece mass estimation device (100) according to additional remark 1 or 2, in which the display (40) displays date and time (47) when estimation of the mass is completed while displaying the graph (41).

### ADDITIONAL REMARK 4

The workpiece mass estimation device (100) according to any one of additional remarks 1 to 3, in which the display (40) displays a temperature (48) of the motor (70) in real time while displaying the graph (41).

### ADDITIONAL REMARK 5

The workpiece mass estimation device (100) according to any one of additional remarks 1 to 4, in which the display (40) displays an operation pattern selection section (44) for selecting an operation condition of the driven object (Dv) while displaying the graph (41).

### ADDITIONAL REMARK 6

The workpiece mass estimation device (100) according to any one of additional remarks 1 to 5, in which when estimation of the mass of the workpiece (W) is not normally completed, the display (40) displays a message (46) that the estimation of the mass is incomplete, while displaying the graph (41).

### ADDITIONAL REMARK 7

The workpiece mass estimation device (100) according to any one of additional remarks 1 to 6, in which the display (40) displays a reset section (43) for initializing the mass estimated while displaying the graph (41).

### ADDITIONAL REMARK 8

The workpiece mass estimation device (100) according to any one of additional remarks 1 to 7, wherein when the physical parameter identified falls outside a predetermined range, the display (40) displays an alarm (42A) while displaying the graph (41).

### ADDITIONAL REMARK 9

The workpiece mass estimation device (100) according to any one of additional remarks 1 to 8,
wherein the graph (41) includes:
an inertia graph (41a) showing a transition of inertia of the driven object (Dv);
a viscous friction coefficient graph (4b1) showing a transition of a viscous friction coefficient in a transmission system for transmitting an output of the motor (70) to the workpiece loading unit (90);
a Coulomb friction coefficient graph (41c) showing a transition of a Coulomb friction coefficient in the transmission system; and
a spring constant graph (41d) showing a transition of a spring constant in the transmission system.

According to the workpiece mass estimation devices (100) of additional remarks 1 to 9, it is possible to easily check whether the repetitive operations are being normally processed.

Although the present disclosure has been described in detail above, the present disclosure is not limited to the individual embodiments described above. Various additions, substitutions, modifications, partial deletions, and the like can be made to these embodiments without departing from the gist of the present disclosure or the spirit of the present disclosure derived from the contents recited in the claims and the equivalents thereof. These embodiments can also be implemented in combination. For example, in the above-described embodiments, the order of each operation and the order of each process are shown as examples, and the present disclosure is not limited thereto. The same applies to the case where numerical values or equations are used in the descriptions of the above-described embodiments.

### EXPLANATION OF REFERENCE NUMERALS

10 identification unit
20 storage unit
30 estimation unit
40 display
41 graph
41a inertia graph
41b viscous friction coefficient graph
41c Coulomb friction coefficient graph
41d spring constant graph
42 mass
42A alarm
43 switching section
44 operation pattern selection section
46 status information
47 date and time information
48 temperature information
50 motor control unit
60 sensor
70 motor
90 workpiece loading unit
100 workpiece mass estimation device
200 machine tool (machine)
W workpiece

1. A workpiece mass estimation device for estimating a mass of a workpiece, for a machine comprising: a workpiece loading unit on which the workpiece is loaded; a motor for driving the workpiece loading unit; a sensor for detecting a state of the motor; and a motor control unit for controlling the motor based on the state of the motor detected,
the workpiece mass estimation device comprising:
an identification unit configured to identify a value of a physical parameter of a driven object driven by an output of the motor from the state of the motor detected and to update the identified value by repetitive operation;
a storage unit configured to store the value of the physical parameter as the value is updated;
an estimation unit configured to estimate the mass of the workpiece from a final value of the values of the physical parameter that have been updated; and
a display configured to display a graph indicating a transition of the value of the physical parameter based on data stored in the storage unit and to display the mass estimated by the estimation unit.

2. The workpiece mass estimation device according to claim 1, wherein the display displays a switching section for performing an operation of switching between execution and suspension of estimation of the mass while displaying the graph.

3. The workpiece mass estimation device according to claim 1, wherein the display displays date and time when estimation of the mass is completed while displaying the graph.

4. The workpiece mass estimation device according to claim 1, wherein the display displays a temperature of the motor in real time while displaying the graph.

5. The workpiece mass estimation device according to claim 1, wherein the display displays an operation pattern selection section for selecting an operation condition of the driven object while displaying the graph.

6. The workpiece mass estimation device according to claim 1, wherein when estimation of the mass of the workpiece is not normally completed, the display displays a message that the estimation of the mass is incomplete, while displaying the graph.

7. The workpiece mass estimation device according to claim 1, wherein the display displays a reset section for initializing the mass estimated while displaying the graph.

8. The workpiece mass estimation device according to claim 1, wherein when the physical parameter identified falls outside a predetermined range, the display displays an alarm while displaying the graph.

9. The workpiece mass estimation device according to claim 1,
wherein the graph comprises:
an inertia graph showing a transition of inertia of the driven object;
a viscous friction coefficient graph showing a transition of a viscous friction coefficient in a transmission system for transmitting an output of the motor to the workpiece loading unit;
a Coulomb friction coefficient graph showing a transition of a Coulomb friction coefficient in the transmission system; and
a spring constant graph showing a transition of a spring constant in the transmission system.
